(19) United States
(12) Patent Application Publication
(10) Pub. No.: US 2006/0174013 A1
(43) Pub. Date: Aug. 3, 2006

(54) Data transfer method, data transfer program, information processing terminal device, and information system

(75) Inventors: Akira Katsumata, Kawasaki (JP); Masaki Okuda, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/236,624

(22) Filed: Sep. 28, 2005

(30) Foreign Application Priority Data
Feb. 3, 2005 (JP) 2005-28135

(51) Int. Cl. G06F 15/16

(52) U.S. Cl. 709/227

(57) ABSTRACT

In a data transfer method for transfer of data by a first information processing terminal device to a second information processing terminal device connected to the first information processing terminal device via a signal line, the first information processing terminal device calculates a maximum required time according to the amount of data for transfer and transfer performance information relating to the connection of the first information processing terminal device with the second information processing terminal device; upon initiating the data transfer processing, the first information processing terminal device continuously confirms that the data transfer processing is in state of execution from the time of initiation of the data transfer processing until the maximum required time has elapsed; and if, when the maximum required time has elapsed, the data transfer processing initiated is confirmed to be continuing, the first information processing terminal device forcibly ends the data transfer processing.

### BACKGROUND OF THE INVENTION

1. Field of the Invention

This invention relates to a data transfer method for data communication performed between information processing terminal devices, when PCs (Personal Computers) or other information processing terminal devices are connected via a wire network or a wireless network. This invention also relates to a program to realize the data transfer method, to an information processing terminal device in which the data transfer method is used, and to an information system in which the data transfer method is employed.

2. Description of the Related Art

At present there exist a wide variety of information processing terminal devices, such as PCs (Personal Computers), PDAs (Personal Digital Assistants), portable telephones, and servers. By interconnecting these information processing terminal devices, either using wires or wirelessly, data is communicated between connected information processing terminal devices. For example, the central computer installed in a main office and the sub-computers installed in a plurality of branch offices may be connected by communication circuits, and in order to ensure that data is the same in the central computer and in the sub-computers, the time after the end of daily operations is used in automated transfer of the data in the central computer to the plurality of sub-computers.

When performing such data transfer, if there is a fault in the information processing terminal device on the receiving side (hereafter abbreviated to “receiving terminal”; in the above example, a sub-computer), or in the communication circuit connecting the two devices, then automated transfer cannot be performed, and so the information processing terminal device on the transmitting side (hereafter abbreviated to “transmitting terminal”; in the above example, the central computer), upon detecting a fault, abandons the transfer of data to the sub-computer, and initiates processing for data transfer to the next sub-computer. The transmitting terminal then schedules processing for retransmission of data, at a modified time, in order to again transmit data to the sub-computer to which data transfer was not performed. In this way, a backlog of data transmission processing is avoided.

Faults detected by a transmitting terminal are limited to system faults in the receiving terminal or in the communication circuits up to the receiving terminal, such as for example loss of the power supply of the receiving terminal; disconnection of the communication circuit between the transmitting terminal and the receiving terminal (including an unplugged cable); the occurrence of a hardware fault in the receiving terminal; failure of the receiving terminal OS (Operating System) to start; denial of login at the receiving terminal (account authentication error); and insufficient hard disk capacity at the receiving terminal (or, non-existence of the write destination).

In the prior art, fault detection is performed taking, as a basis for judgment, the continuation over a fixed length of time (a timeout time) of a state in which a response is not obtained from the receiving terminal; a number of methods have been proposed for setting the timeout time (for example, Japanese Patent Laid-open No. 2003-50762, Japanese Patent Laid-open No. 2000-71570, and Japanese Patent Laid-open No. 2003-333271).

However, the inventors of this application has confirmed that in some cases data transfer processing may be backlogged at a step of processing for a certain receiving terminal, despite the fact that no faults have occurred in either the receiving terminal, the transmitting terminal or in the communication circuit between the transmitting terminal and the receiving terminal. Such cases may be, for example, when a NIS (Network Information Service) server is constructed in which account information and similar for users using receiving terminals belonging to domains are stored in the domains belonging to the receiving terminals, and the NIS server is down, or when a file server is constructed in a domain and the file server goes down while the receiving terminal is writing data transferred from the transmitting terminal.

In the former case, if for example ftp (File Transfer Protocol) is used for the data transfer, during login authentication to the receiving terminal the receiving terminal repeats access until a NIS server fault can be detected. Thus there is a backlog of data transfer processing. In the latter case, the receiving terminal repeats access until a file server fault can be detected, and there is a backlog of data transfer processing.

In these cases, there is no anomaly in the communication circuit connecting the transmitting terminal and the receiving terminal, and responses from the receiving terminal can be confirmed, so that a fault is not detected by the transmitting terminal. Hence the transmitting terminal enters a semi-permanent wait state, and can neither switch the destination for transfer to a new receiving terminal and initiate data transfer processing, nor perform data resend processing. Consequently a situation occurs in which data transfer processing does not end even after the estimated time of the end of the operation passes, possibly even having an effect on the operations of the following day, and so is undesirable.

Hence one object of this invention is to provide a data transfer method, as well as a related data transfer program, data transfer processing terminal, and information system such that, even though conventionally the transmitting terminal detects no fault as described above, a situation in which overall operation time lags due to a backlog of data transfer processing is detected as a fault, and in this case data transfer processing can be switched to another receiving terminal.

### SUMMARY OF THE INVENTION

The above objects are attained by the provision, as a first aspect of the invention, of a data transfer method for a first information processing terminal device to transfer data to a second information processing terminal device connected via a signal line to the first information processing terminal device, characterized in that the first information processing terminal device calculates the maximum required time according to the amount of data for transfer and transfer performance information relating to the connection between the first information processing terminal device and the second information processing terminal device; the first information processing terminal device, upon initiating processing to transfer the data, continuously confirms that the data transfer processing is in a state of execution from the time of initiation of the transfer processing for the data until the maximum required time has elapsed; and, when the maximum required time has elapsed, if the first information processing terminal device confirms that the data transfer processing initiated at the time of initiation is continuing, the first information processing terminal device forcibly ends the data transfer processing.

In a preferred embodiment of the above first aspect of the invention, the first information processing terminal device, upon confirming that the data transfer processing ends normally before the maximum required time has elapsed, updates the transfer performance information based on the amount of data transferred and on the time required for transfer of the data.

In a preferred embodiment of the above first aspect of the invention, the data transfer processing is executed as a background process, and the first information processing terminal device, when forcibly ending processing, issues a command to forcibly end the background process.

Further, the above objects are attained by the provision, as a second aspect of the invention, of a program characterized by causing a computer, which performs processing to transfer data to an information processing terminal device connected via a signal line, to calculate a maximum required time according to the amount of data for transfer and transfer performance information relating to the connection between the computer and the information processing terminal device; upon initiation by the computer of processing to transfer the data, to continuously confirm that the data transfer processing is in a state of execution from the time of initiation of the transfer processing for the data until the maximum required time has elapsed; and, when the maximum required time has elapsed, if it is confirmed that the data transfer processing initiated at the time of initiation is continuing, to forcibly end the data transfer processing.

Further, the above objects are attained by the provision, as a third aspect of the invention, of an information processing terminal device, which performs processing to transfer data to another information processing terminal device connected via a signal line, having a storage portion which stores a control program and transfer performance information relating to the connection between the information processing terminal device and the other information processing terminal device, and a control portion, which reads the control program from the storage portion and executes the data transfer processing; and which is characterized in that the control portion, through execution of the control program, realizes a calculation portion which calculates a maximum required time according to the amount of data for transfer and the transfer performance information; a monitoring portion which, upon initiation of data transfer processing by the control portion, continuously confirms that the data transfer processing is in an execution state from the time of initiation of the data transfer processing until the maximum required time has elapsed; and a cancellation portion which, when the maximum required time has elapsed, in cases where the data transfer processing initiated at the initiation time is confirmed to be continuing, forcibly ends the data transfer processing.

Further, the above objects are attained by the provision, as a fourth aspect of the invention, of an information system comprising a transmitting terminal which transmits stored data and a plurality of receiving terminals connected to the transmitting terminal via signal lines and which receive the data; the transmitting terminal of which has a storage portion which stores the data, a control program, and transfer performance information relating to the connections between the transmitting terminal and each of the receiving terminals, and a control portion which reads and executes the control program; and which is characterized in that the control portion, through execution of the control program, realizes a calculation portion which calculates a maximum required time according to the amount of data for transfer and the transfer performance information relating to the connection between the transmitting terminal and one receiving terminal specified among the plurality of receiving terminals; a monitoring portion which, upon initiation of processing to transfer the data to the one receiving terminal, continuously confirms that the data transfer processing is in an execution state from the time of initiation of the data transfer processing until the maximum required time has elapsed; and a cancellation portion which, when the maximum required time has elapsed, in cases where the data transfer processing initiated at the initiation time is confirmed to be continuing, forcibly ends the processing for data transfer to the one receiving terminal, and specifies to the calculation portion a new receiving terminal different from the one receiving terminal.

By means of this invention, a fault occurring in other than the receiving terminal or the communication circuit connecting the transmitting terminal to the receiving terminal can be detected by the transmitting terminal, and switching of data transmission to another receiving terminal, or data resend processing, can be performed. As a result, the transmitting terminal can be prevented from entering a semi-permanent wait state, and a situation in which data transfer processing does not end even when the predicted task end time has passed can be avoided.

### BRIEF DESCRIPTION OF THE DRAWINGS

FIG. 1 shows the configuration of the information system in one aspect of the invention;

FIG. 2 is a block diagram of an information processing terminal device in one aspect of the invention;

FIG. 3 is a functional block diagram to explain the control portion of the transmitting terminal in one aspect of the invention;

FIG. 4 is an example of the data configuration of transfer performance information stored in the storage portion; and,

FIG. 5 is a flowchart to explain operation of the transmitting terminal 1 in one aspect.

### DESCRIPTION OF THE PREFERRED EMBODIMENTS

Below, aspects of the invention are explained referring to the drawings. However, the technical scope of the invention is not limited to these aspects, but extends to the inventions described in the scope of claims and to inventions equivalent thereto.

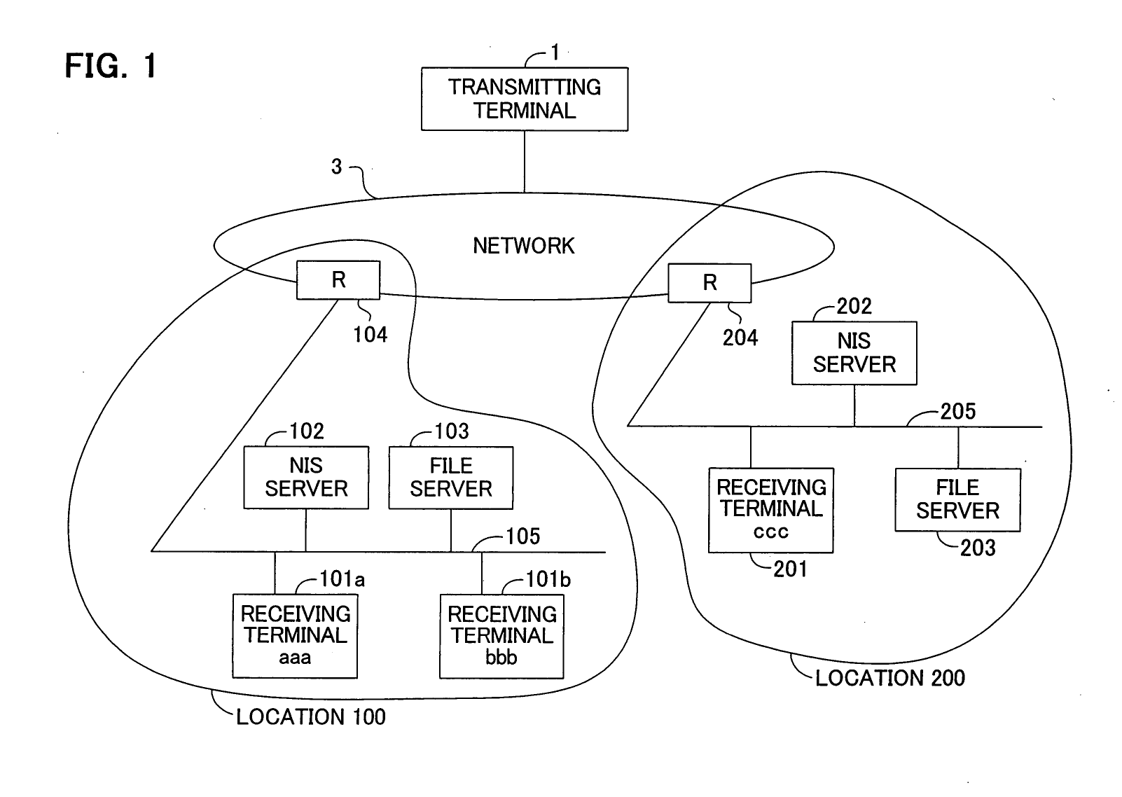

FIG. 1 shows the configuration of the information system in one aspect of the invention. A transmitting terminal 1 and a plurality of receiving terminals 101a, 101b, 201 are connected via a network 3, and data stored in the transmitting terminal 1 is transmitted to each of the receiving terminals 101a, 101b, 201. The transmitting terminal 1 initiates processing for data transfer to the receiving terminals 101a, 101b of the location 100, and when this ends, performs processing to transfer data to the receiving terminal 201 of the location 200.

At the location 100 accommodating the receiving terminal 101a, a LAN (Local Area Network) 105 is constructed, and is connected to a network 3 via a router 104. The LAN 105 is connected to a NIS server 102 which manages account information (for example, usernames and passwords) for users using the receiving terminals 101a and 101b and host information (host names and IP addresses) for the receiving terminals 101a, 101b, as well as to a file server 103 providing its own storage area to each of the receiving terminals as storage areas for receiving terminals comprised by the location 100.

Similarly at the location 200, a LAN 205 is constructed, and is connected to a network 3 via a router 204. The LAN 205 is likewise connected to a NIS server 202 and file server 203. A plurality of receiving terminals may exist at each of the locations, regardless of the number shown in FIG. 1.

A characteristic of the aspect of the invention is that the transmitting terminal 1 calculates the maximum value of the time to be required for transfer, according to the amount of data for transfer and the transfer performance, related to the connection between the transmitting terminal and the receiving terminal which is the transfer destination. After processing for data transfer to the receiving terminal is initiated, if the data transfer processing is not completed even after this calculated prescribed time has elapsed, the data transfer processing is forcibly ended. Thus at location 1 in FIG. 1, even if the NIS server 102 and file server 103 are down, in processing for data transfer to the receiving terminal 101a the data transfer processing can be immediately switched to the next receiving terminal without causing backlog, so that processing is performed for data transfer to the receiving terminal 101b or to the receiving terminal 201 at location 200. At a later time, processing is performed to resend to the receiving terminal to which data transfer was forcibly ended.

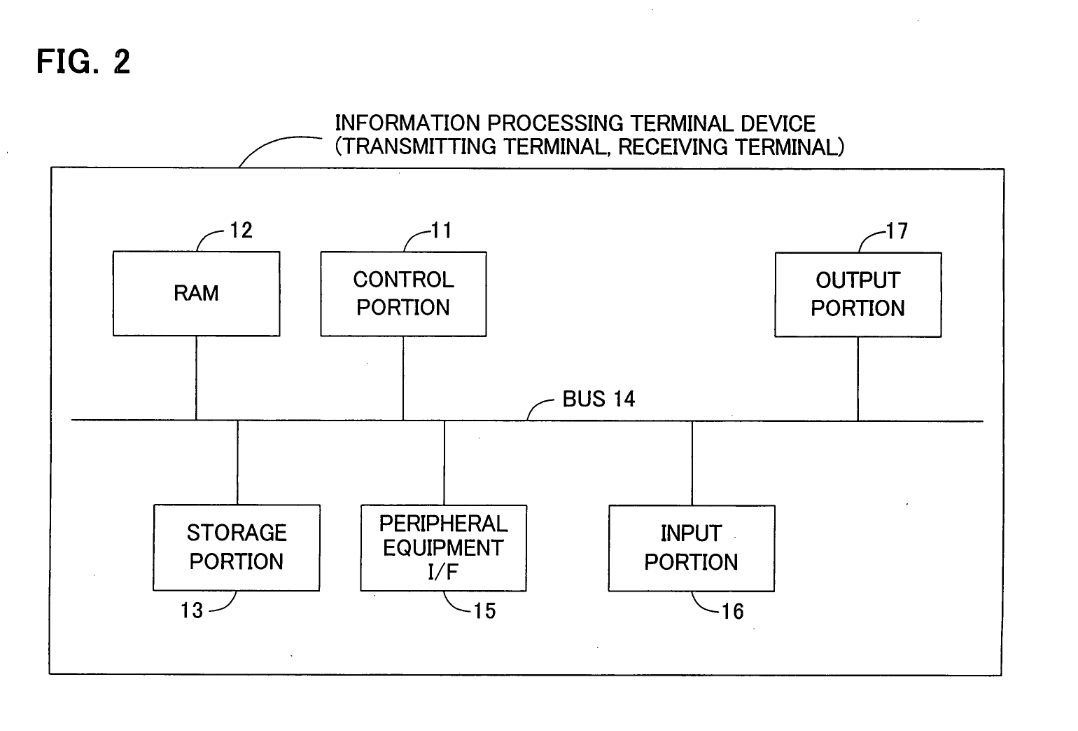

FIG. 2 is a block diagram of an information processing terminal device (transmitting terminal 1, receiving terminal 101a, 101b, 201) in an aspect of the invention. The information processing terminal device is a desktop PC, notebook PC, PDA (Personal Digital Assistant), server, workstation, portable telephone, or similar, and comprises a control portion 11, RAM (Random Access Memory) 12, storage portion 13, interface for connection to peripheral equipment (peripheral equipment I/F) 15, input portion 16 used for input of information, and output portion 17 to output information and provide information to the user, all interconnected by a bus 14.

The control portion 11 comprises a CPU (Central Processing Unit), not shown, which executes a program stored in RAM 12 and controls the various portions comprised by the information processing terminal device. The RAM 12 is storage means for temporarily storing a program and computation results in the processing of the information processing terminal device. The storage portion 13 is nonvolatile storage means such as a hard disk, optical disc, magnetic disc, flash memory or similar, and stores various data and an OS (Operating System) and other programs which are read into RAM 12.

The peripheral equipment I/F 15 is an interface to facilitate connection of peripheral equipment to the information processing terminal device, and is a parallel port, USB (Universal Serial Bus) port, PCI card slot, or similar. Peripheral equipment may be a printer, TV tuner, SCSI (Small Computer System Interface) equipment, audio equipment, drive device, memory card reader/writer, network interface card, wireless LAN card, modem card, keyboard or mouse, display device, or a variety of other devices. The mode of connection of the peripheral equipment and the information processing terminal device may be by wire or wirelessly.

The output portion 17 is output means which outputs information and provides a user with information, and is display means for displaying information to a user such as a CRT (Cathode Ray Tube), liquid crystal display, or similar. The input portion 16 is input means for input of requests by users, such as a keyboard or mouse.

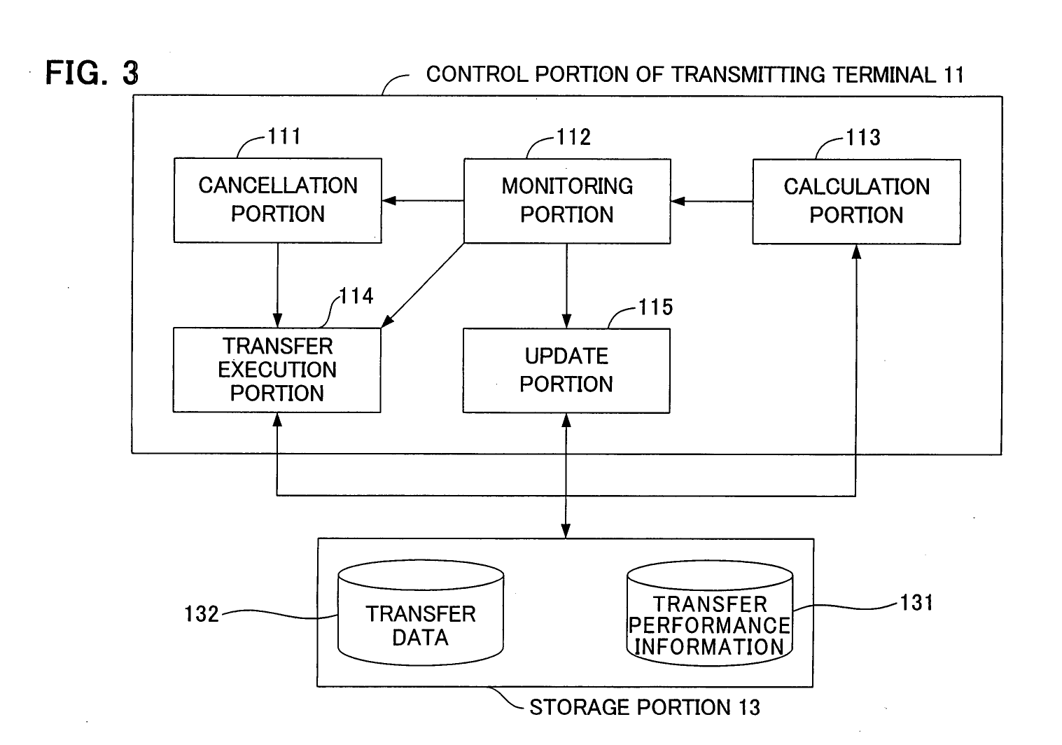

FIG. 3 is a functional block diagram to explain the control portion 11 of the transmitting terminal 1 in an aspect of the invention. The control portion 11 of the transmitting terminal 1 comprises a cancellation portion 111, monitoring portion 112, calculation portion 113, transfer execution portion 114, and update portion 115. Each of the functional portions of the control portion 11 can be realized by a program executed by a CPU, not shown, comprised by the control portion 11, but can also be realized by hardware.

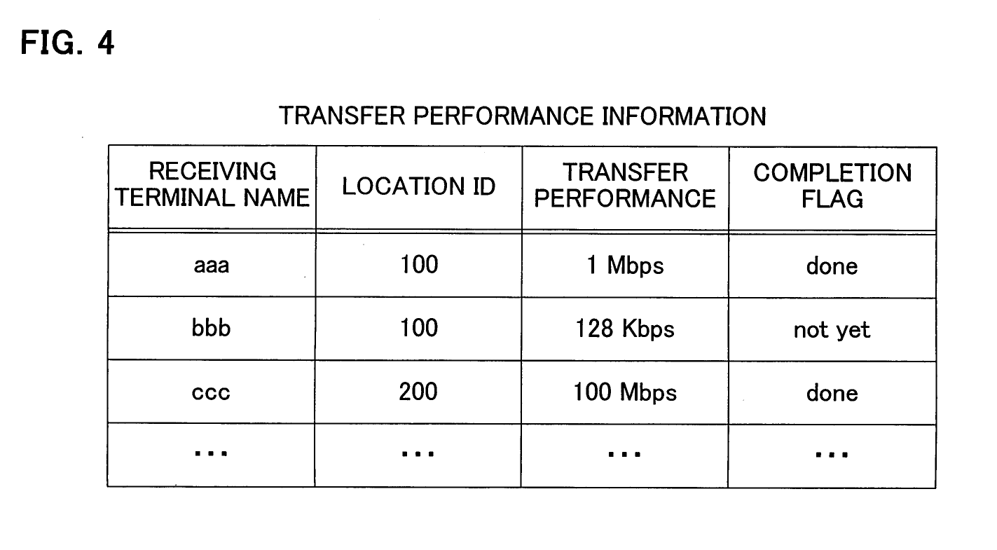

The calculation portion 113, upon initiation of data transfer processing by the transmitting terminal 1, references the transfer data 132 of the storage portion 13, acquires the quantity of the data for transfer 132, references the transfer performance information 131, and obtains the “transfer performance” (see FIG. 4 below) corresponding to the receiving terminal which is the transfer destination.

FIG. 4 is an example of the data configuration of transfer performance information 131 stored in the storage portion 13. The transfer performance information of FIG. 4 comprises the data fields “receiving terminal name”, “location ID”, “transfer performance”, and “completion flag”. The “receiving terminal name” is a name (host name) specifying the receiving terminal. The “location ID” is an identifier used to identify the location accommodating the receiving terminal.

“Transfer performance” is a value indicating the transfer capability relating to the connection between the transmitting terminal 1 and the receiving terminals, and is set in advance according to the bandwidth of the communication circuit used. The value indicating the transfer performance can be set taking into account, in addition to the bandwidth of the communication circuit, the performance of the network equipment used as communication circuit relays and the calculation performance ability of the transmitting terminal and receiving terminal. The transfer performance is updated as necessary through processing by the update portion 115 described below. Hence even if a theoretical value is set as the initial value, the value is modified so as to become smaller according to the conditions of actual transfers.

In FIG. 4, the transfer performance relating to the connection between the receiving terminal aaa accommodated by location 100 and the transmitting terminal 1 is set to 1 Mbps (where M indicates 10⁶, and bps stands for “bits per second”), and the transfer performance relating to the connection between the receiving terminal bbb at the same location 100 and the transmitting terminal 1 is set to 128 Kbps (where K indicates 10³), due to the effect of relay equipment (not shown in FIG. 1).

The “completion flag” is flag information indicating whether data transfer processing has been completed; this entry stores “done” for a receiving terminal for which the processing is completed, and stores “not yet” for a receiving terminal for which processing is not yet completed. In FIG. 4, a receiving station name is used to specify the receiving station, but in addition an IP address, a MAC address, a model-specific number, or another terminal identifier can be used to specify the receiving terminal.

Returning to FIG. 3, the calculation portion 113, upon obtaining the amount of data for transfer and the transfer performance, calculates the time required for processing to transfer the data to the receiving terminal by dividing the data amount by the transfer performance. The time calculated in this way is the limiting value (maximum value) of the time for performing processing to transfer data to the receiving terminal. That is, should the data transfer processing continue for a time beyond this limiting value, an anomalous state will be judged to have occurred.

The monitoring portion 112 has time measurement means (not shown) to measure time, and when the maximum required time for data transfer processing is calculated by the calculation portion 113, starts the transfer execution portion 114 and periodically confirms the state of execution of the data transfer processing, from the initiation of transfer processing until the maximum required time has elapsed. If the data transfer processing continues even after the maximum required time has elapsed, the monitoring portion 112 starts the cancellation portion 111. If the data transfer processing ends before the maximum required time has elapsed, and it is confirmed that all of the transfer data 132 has been transferred normally to the receiving terminal, the monitoring portion 112 starts the update portion 115.

The transfer execution portion 114 uses a prescribed protocol to transmit the transfer data 132 to the receiving terminal. For example, the transfer execution portion 114 executes a command comprised by the OS (for example, an ftp command) to realize communication based on a prescribed protocol, to effect automated transfer.

The cancellation portion 111 is started by the monitoring portion 112 when the data transfer processing continues even after the maximum required time has elapsed, and forcibly ends the continuing data transfer processing. For example, the cancellation portion 111 executes a command comprised by the OS (for example, a “kill” command) to forcibly end a process generated by the above-mentioned ftp command, thus forcibly ending the process.

The update portion 115 is started when it is confirmed that all of the transfer data 132 has been transferred normally to the receiving terminal before the maximum required time has elapsed. The monitoring portion 112 can judge, by referencing the return value (end status information) of the ftp command in the above example, whether transfer to the receiving terminal has been completed normally. While there are differences depending on the OS, when for example all the data has been transferred normally the ftp command return value may be 0 (zero), whereas when an anomaly has occurred a return value may be returned according to the type of anomaly.

The update portion 115, upon being started, calculates a new transfer performance by dividing the total amount of transferred data 132 by the time actually required for transfer, and updates the transfer performance information (FIG. 4) as the “transfer performance” for the corresponding receiving terminal. For example, if the initial value of the transfer performance for the receiving terminal aaa in FIG. 4 is 1 Mbps, and 250 seconds were actually required to transmit 100 Mb of data from the transmitting terminal 1 to the receiving terminal 111, then the transfer performance value would be updated to 400 Kbps.

In this aspect, a file for name resolution (for example, file /etc/hosts), used to convert the host name used in FIG. 4 into an IP address, is stored in the storage portion 13. Another name resolution means (an NIS server for the transmitting terminal) may also be used. In FIG. 4, it is not necessary that a host name be used to specify the receiving terminal, and if an IP address is used, the above name resolution file or name resolution means is unnecessary.

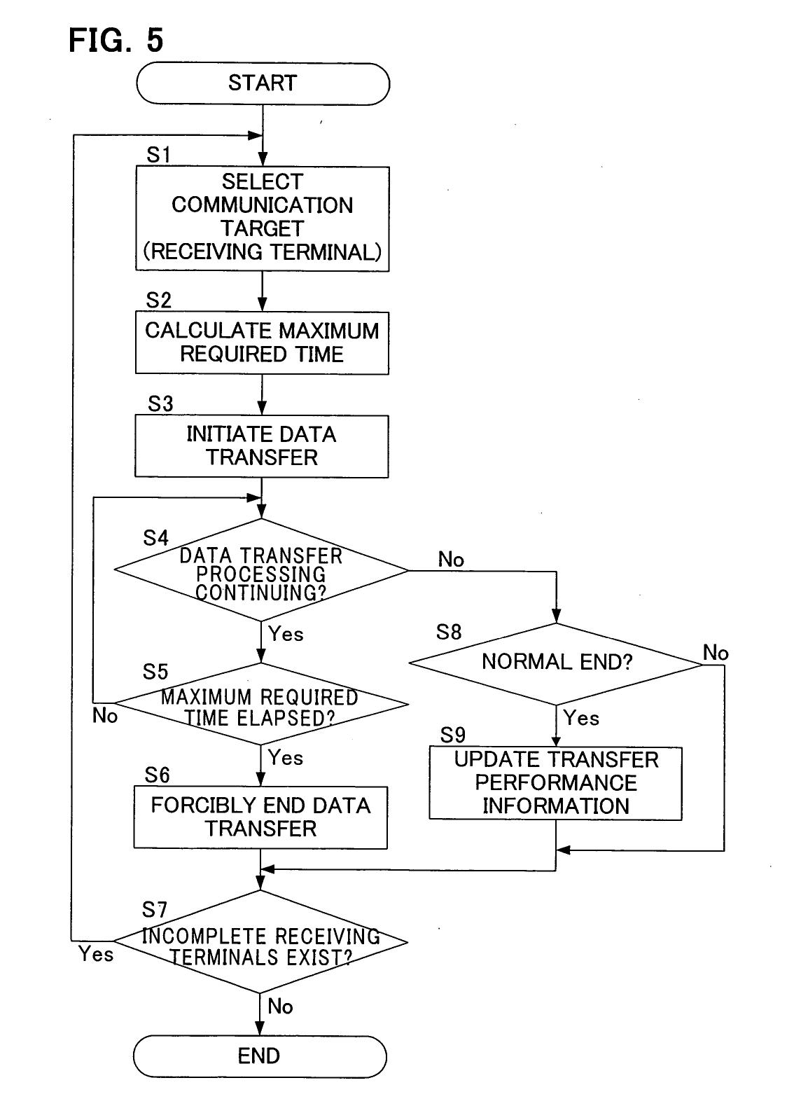

FIG. 5 is a flowchart to explain operation of the transmitting terminal 1 in this aspect. The calculation portion 113 selects the first receiving terminal to which data is to be transferred (S1). The calculation portion 113 references the transfer performance information 131 stored in the storage portion 13, and determines the host name of the receiving terminal.

Next, the calculation portion 113 calculates the maximum required time which is the time required for processing to transfer data to the receiving terminal selected in step S1 (S2). The calculation portion 113 references the transfer performance information 131 to obtain the transfer performance corresponding to the host determined in step S1, and references the storage portion 13 to obtain the amount of data for transfer 132. The calculation portion 113 then divides the amount of data by the transfer performance to calculate the maximum required time.

Next, the transfer execution portion 113 initiates data transfer processing (S3). When the maximum required time is calculated by the calculation portion 113 in step S2, the monitoring portion 112 explained using FIG. 3 is started, and the monitoring portion 112 starts the transfer execution portion 114.

In step S3, the transfer execution portion 114 references the file for name resolution stored in the storage portion 13, and obtains the IP address of the receiving terminal selected in step S1. The transfer execution portion 114 then executes, for example, an ftp command comprised by the OS, to initiate the transfer of transfer data 132 in the storage portion 13.

When the data transfer processing of step S3 is initiated, the monitoring portion 112 periodically confirms the data transfer processing initiated in step S3, that is, continuously monitors the data transfer, until the maximum required time calculated in step S2 has elapsed (S4). The intervals of confirmation by the monitoring portion 112 may be one second, or may be the maximum required time divided into n equal parts, and no constraints are imposed thereupon. If the transfer processing is for example performed by means of the above-described ftp command, then confirmation as to whether the data transfer processing is in a state of execution can be performed by the monitoring portion 112 by executing a process existence confirmation command (for example, a “ps” command), and judging whether the corresponding process exists.

When the monitoring portion 112 confirms that the data transfer processing is continuing (“Yes” in S4), the monitoring portion 112 then judges whether the maximum required time has elapsed from the initiation of data transfer processing in step S3 (S5). If data transfer processing is continuing even though the maximum required time has elapsed (“Yes” in S5), the cancellation portion 111 is started, and the cancellation portion 111 forcibly ends the continuing data transfer processing (S6). As explained in FIG. 3, step S6 is performed by for example the cancellation portion 111 that issues a “kill” command for the process generated by execution of the above-described ftp command.

When step S6 is completed, the cancellation portion 111 checks whether there is a “not yet” entry in the “completion flag” portion of the transfer performance information in FIG. 4, and if there exists a receiving terminal for which data transfer processing has not yet completed (“Yes” in S7), the receiving terminal for which data transfer processing has not completed is specified and is provided to the calculation portion 113. The calculation portion 113 performs the processing beginning from step S1 for the receiving terminal specified by the cancellation portion 111.

In step S4, if the monitoring portion 112 confirms that the data transfer processing has ended (“No” in S4), the monitoring portion 112 checks whether the data transfer processing has ended normally (S8). As explained above in FIG. 3, the monitoring portion 112 can make a judgment by referencing the return value (end status information) of the above-described ftp command.

If processing has ended normally (“Yes” in S8), the update portion 115 calculates the new transfer performance by dividing the amount of the transferred data 132 by the time actually required for transfer, and updates the transfer performance information (FIG. 4) as the “transfer performance” for the corresponding receiving terminal (S9); processing then advances to step S7, and the necessity for data transfer processing for a new receiving terminal is judged. If however processing has not ended normally (“No” in S8), updating of the transfer performance information (step S9) is skipped.

In step S5, if the maximum required time has not elapsed (“No” in S5), processing returns to step S4 and the continuation of data transfer processing is confirmed periodically. If in step S7 data transfer processing has been completed for all receiving terminals (“No” in S7), the operation of the transmitting terminal 1 ends.

By means of the aspect explained above, a transmitting terminal can detect a fault occurring in other than the receiving terminal or in the communication circuit connecting the transmitting terminal to the receiving terminal, and can switch data transfer to another receiving terminal or can perform data resend processing. By this means, the transmitting terminal can be prevented from entering a semi-permanent wait state, and a situation in which data transfer processing does not end even when the predicted task end time has passed can be avoided.

For example, when using an ftp command to perform data transfer processing, by causing the ftp command to be executed as a background process, the transmitting terminal can execute control to halt the process even when operation is not completed after the maximum required time has elapsed. And, the wait time can be calculated as the maximum required time according to the amount of transfer data and the transfer performance, and by executing control to monitor the process the transmitting terminal can be prevented from entering a semi-permanent wait state. Further, by setting a transfer performance for each receiving terminal, detailed settings can be set individually. And by measuring the actual data transfer performance and reflecting the measured results in the transfer performance setting, the calculated maximum required time can be optimized, to prevent the occurrence of reduction of the task time as a result of temporarily setting a long maximum required time and to prevent the occurrence of failure for data processing to end normally as a result of a temporarily setting a short maximum required time.

The NIS server and file server provided in each of the locations in FIG. 1 are examples; but in the cases of other servers accessed by a receiving terminal during data transfer processing (application servers, mail servers, web servers, SNMP servers, or similar) also, a fault which cannot be detected in the prior art may cause a problem of data transfer processing backlogs. The protocol used in data transfer processing is not limited to ftp, but may be http, tftp, snmp, telnet, or similar.

What is claimed is:

1. A data transfer method comprising a first information processing terminal device that transfers data to a second information processing terminal device connected via a signal line to said first information processing terminal device, wherein
said first information processing terminal device calculates the maximum required time according to the amount of data for transfer and transfer performance information relating to the connection between said first information processing terminal device and said second information processing terminal device;
said first information processing terminal device, upon initiating processing to transfer said data, continuously confirms that the data transfer processing is in a state of execution from the time of initiation of the transfer processing of said data until said maximum required time has elapsed; and,
when said maximum required time has elapsed, if said first information processing terminal device confirms that said data transfer processing initiated at said time of initiation is continuing, said first information processing terminal device forcibly ends said data transfer processing.

2. The data transfer method according to claim 1, wherein said first information processing terminal device, upon confirming that transfer processing for said data ends normally before said maximum required time has elapsed, updates said transfer performance information based on the amount of said data transferred and on the time required to transfer said data.

3. The data transfer method according to claim 1, wherein said data transfer processing is executed as a background process, and, when said forcible ending is performed, said first information processing terminal device issues a command to forcibly end said background process.

4. A program causing a computer which performs processing to transfer data to an information processing terminal device connected via a signal line to perform the steps of:
calculating a maximum required time, according to the amount of data to be transferred and transfer performance information relating to the connection between said computer and said information processing terminal device;
upon initiation of said data transfer processing by said computer, continuously confirming that said data transfer processing is in a state of execution, until said maximum required time has elapsed from the time of initiation of transfer processing of said data; and,
when said maximum required time has elapsed, upon confirming that said data transfer processing initiated at said initiation time is continuing, forcibly ending said data transfer processing.

5. The program according to claim 4, further executing, when said data transfer processing is confirmed to end normally before said maximum required time has elapsed, a step of updating said transfer performance information based on the amount of said transferred data and on the time required for transfer of said data.

6. The program according to claim 4, wherein said data transfer processing is executed as a background process, and, when said forcible ending is performed, said computer issues a command to forcibly end said background process.

7. An information processing terminal device, which performs processing to transfer data to another information processing terminal device connected via a signal line, comprising
a storage portion which stores a control program and transfer performance information relating to the connection between said information processing terminal device and said other information processing terminal device and
the control portion which reads said control program from said storage portion and executes transfer processing of said data, wherein
said control portion, by executing said control program, realizes a calculation portion which calculates a maximum required time according to the amount of data for transfer and said transfer performance information; a monitoring portion which, upon initiation of processing to transfer said data by said control portion, continuously confirms that said data transfer processing is in a state of execution, from the time of initiation of said data transfer processing until said maximum required time has elapsed; and a cancellation portion which, when said maximum required time has elapsed, in cases where said data transfer processing initiated at said time of initiation is confirmed to be continuing, forcibly ends said data transfer processing.

8. The information processing terminal device according to claim 7, wherein said control portion executes said control program to further realize an update portion which, when it is confirmed that said data transfer processing ends normally before said maximum required time has elapsed, updates said transfer performance information based on the amount of said data transferred and on the time required for transfer of said data.

9. The information processing terminal device according to claim 7, wherein said data transfer processing is executed as a background process, and, when said forcible ending is performed, said cancellation portion issues a command to forcibly end said background process.

10. An information system, comprising a transmitting terminal which transmits stored data and a plurality of receiving terminals, connected to said transmitting terminal via signal lines, which receive said data, wherein
said transmitting terminal has a storage portion which stores said data, a control program, and transfer performance information relating to the connection between said transmitting terminal and each of said receiving terminals and a control portion which reads and executes the control program; and,
said control portion, by executing said control program, realizes a calculation portion which calculates a maximum required time according to the amount of said data for transfer and said transfer performance information relating to the connection between said transmitting terminal and one receiving terminal specified from among said plurality of receiving terminals; a monitoring portion which, upon initiation of processing to transfer said data to said one receiving terminal, continuously confirms that said data transfer processing is in a state of execution, from the time of initiation of said data transfer processing until said maximum required time has elapsed; and a cancellation portion which, when said maximum required time has elapsed, in cases where said data transfer processing initiated at said time of initiation is confirmed to be continuing, forcibly ends processing to transfer said data to said one receiving terminal, and provides a specification of a new receiving terminal, different from said one receiving terminal, to said calculation portion.

11. The information system according to claim 10, wherein said control portion executes said control program to further realize an update portion which, when it is confirmed that said data transfer processing ends normally before said maximum required time has elapsed, updates said transfer performance information based on the amount of said data transferred and on the time required for transfer of said data.

12. The information processing terminal device according to claim 10, wherein said data transfer processing is executed as a background process, and, when said forcible ending is performed, said cancellation portion issues a command to forcibly end said background process.
